(19) United States
(12) Patent Application Publication
(10) Pub. No.: US 2007/0226335 A1
(43) Pub. Date: Sep. 27, 2007

(54) INFORMATION PROCESSING SYSTEM AND PROGRAM FOR CAUSING COMPUTER TO EXECUTE CLIENT DEVICE CONTROL METHOD

(75) Inventors: Fumio KOYAMA, Hara-mura (JP); Yasuhito NAGATOMO, Shiojiri (JP); Atsushi NARUSAWA, Hino (JP)

Correspondence Address: HARNESS, DICKEY & PIERCE, P.L.C., P.O. BOX 828, BLOOMFIELD HILLS, MI, 48303, US

(73) Assignee: SEIKO EPSON CORPORATION, Tokyo (JP)

(21) Appl. No.: 11/690,322

(22) Filed: Mar. 23, 2007

(30) Foreign Application Priority Data
Mar. 24, 2006 (JP) 2006-083049

(51) Int. Cl. G06F 15/173

(52) U.S. Cl. 709/224; 709/225

(57) ABSTRACT

An information processing system includes: a host device, and a plurality of client devices, each of which is in communication with the host device, the plurality of client devices having unique identification information for specifying each of them. The host device includes: a specification unit which detects the identification information and specifies each of the client devices; an operation determination unit which determines details of an operation carried out on the client device specified by the specification unit; an operation detail recording unit which records information correlating the client device specified by the specification unit and the details of the operation carried out on the client device which has been determined by the operation determination unit; and an operation processing unit which, based on the information recorded in the operation detail recording unit, generates information obtained as a result of operations consecutively executed between the plurality of client devices, and transmits the generated information to any of the plurality of client devices.

### BACKGROUND

1. Technical Field

The present invention relates to an information processing system and a program for causing execution of a client device control method, and particularly to an information processing system, including a host device and a plurality of client devices, which operates by control of the host device, and a program for causing execution of a client device control method.

2. Related Art

A host-client system type information processing system, in which a host device and a client device are connected and, in accordance with an operation performed on the client device side, the host device controls the client device, is used in many fields. A WEB (World-Wide Web) system for a network and a PIM (Personal Information Manager) service for a mobile phone can be taken as examples of the host-client system. Also, JP-A-2003-157184 can be taken as a related art of the host-client system.

JP-A-2003-157184, having a client-server-computer configuration, is further configured such that, by communicating information related to a finish or execution condition of a program between the client computer and the server computer, the system monitors a result of the execution of the program.

Meanwhile, in recent years, a display medium called electronic paper has increasingly come into practical use. The electronic paper is a display device, being configured by combining a thin display and a comparatively small and simple display control device, in which it is possible, using the same handling as for paper, to display an image and edit the displayed image. The thus simple electronic paper is applied as the client device of the host-client system and, by providing a large portion of the display control on the host device side, it is possible to achieve a further reduction in thickness and constitutional complexity of the electronic paper.

However, with respect to either of the host-client arrangements discussed above, although such system may be contemplate the host device being connected to a plurality of the client devices, neither of them enables a single user to control the plurality of client devices. For this reason, it has not been possible to control an operation carried out straddling the plurality of client devices such as, for example, an operation in which an operator carries out a copying operation in one client device, and pastes a copied text or the like into another client device.

### SUMMARY

An advantage of some aspects of the invention is to provide a host-client type information processing system in which, by one host device being connected to a plurality of client devices, it is possible to control operations executed straddling the plurality of client devices.

In order to achieve the above advantage, according to an aspect of the invention, an information processing system includes: a host device; and a plurality of client devices, each of which is in communication with the host device, each of the plurality of client devices having unique identification information for specifying that client device. The host device includes: a specification unit which detects the identification information and specifies each of the client devices; an operation determination unit which determines details of an operation carried out on the client device specified by the specification unit; an operation detail recording unit which records information correlating the client device specified by the specification unit and the details of the operation carried out on the client device which has been determined by the operation determination unit; and an operation processing unit which, based on the information recorded in the operation detail recording unit, generates information obtained as a result of operations consecutively executed between the plurality of client devices, and transmits the generated information to any of the plurality of client devices.

According to this kind of aspect of the invention, in the information processing system including the host device and the plurality of client devices in communication with the host device, it is possible to specify each of the plurality of client devices. Also, it is possible to determine the details of the operation carried out on the specified client device, and record the information correlating the specified client device and the determined operation details. Furthermore, as well as it being possible to record operation history information indicating details of the operations consecutively executed between the plurality of client devices, it is possible, based on the operation history information, to transmit information obtained as a result of the consecutively executed operations to any of the plurality of client devices.

Consequently, the invention can provide the host-client type information processing system in which, by one host device being connected to the plurality of client devices, it is possible to control the operations executed straddling the plurality of client devices.

Also, in the information processing system according to the aspect of the invention, the operation determination unit, being connected by wire or wirelessly to the host device, transmits the details of the operation carried out on the client device to the host device.

According to this kind of aspect of the invention, even in the event that the host device and the plurality of client devices are installed distanced from one another, it is possible to transmit the operation details from the host device to the client devices.

Also, in the information processing system according to the aspect of the invention, at least one of the plurality of client devices includes a display device which displays an image and has a non-volatile storing property.

According to this kind of aspect of the invention, it is possible to establish an information processing system which, while enabling one operator to use the plurality of client devices, is comparatively inexpensive and simple in configuration.

Also, according to another aspect of the invention, a program for causing execution of a method of controlling a plurality of client devices in a host device of an information processing system including the host device and the client devices, includes: a specification operation of specifying each of the plurality of client devices; an operation determination operation of determining details of an operation carried out on the client device specified in the specification operation; an operation history recording operation of recording information correlating the client device specified in the specification operation and the details of the operation carried out on the client device which has been determined in the operation determination operation; and an operation processing operation of, based on the information recorded in the operation history recording operation, transmitting information obtained as a result of operations consecutively executed between the plurality of client devices to any of the client devices.

According to this kind of aspect of the invention, it is possible to specify each of the plurality of client devices, and determine the details of the operation carried out on the specified client device. Then, it is possible to record in advance the information correlating the specified client device and the determined details of the operation carried out on the client device and, based on the information, transmit the information obtained as the result of the operations consecutively executed between the plurality of client devices to any of the client devices.

Consequently, the invention can provide the program for causing the computer to execute the client device control method in which, by one host device being connected to the plurality of client devices, it is possible to control the operations executed straddling the plurality of client devices.

### BRIEF DESCRIPTION OF THE DRAWINGS

The invention will be described with reference to the accompanying drawings, wherein like numbers reference like elements.

FIG. 1 is a diagram illustrating an information processing system according to an embodiment of the invention.

FIG. 2 is a diagram that more specifically illustrates an internal configuration of a host device and an exemplary client device shown in FIG. 1.

FIG. 3 is a flowchart illustrating an overall operation of the information processing system according to an embodiment of the invention.

FIG. 4 is a flowchart illustrating an operation carried out in the host device of the information processing system according to an embodiment of the invention.

FIG. 5 is a flowchart illustrating an operation carried out in the host device of the information processing system according to another embodiment of the invention.

### DESCRIPTION OF EXEMPLARY EMBODIMENTS

Hereafter, a description will be given, with reference to the drawings, of examples of an image processing system and a program for causing execution of a client device control method according to embodiments of the invention.

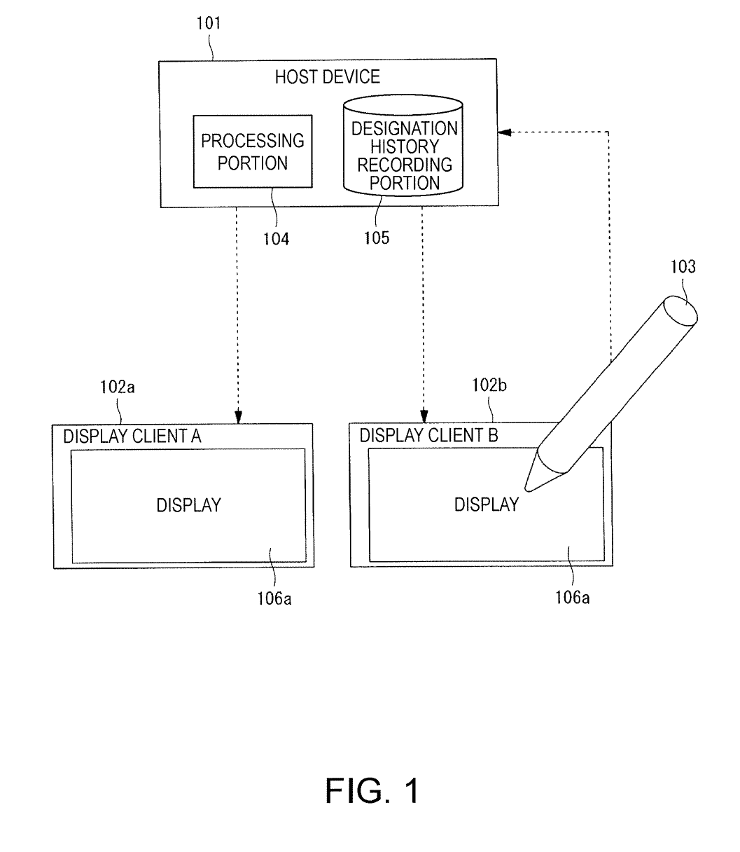

FIG. 1 is a diagram for illustrating an information processing system according to an embodiment of the invention. The information processing system shown in the figure includes a host device 101 and a plurality of client devices 102a and 102b, each of which operates by control of the host device 101.

In the present embodiment, a host device process of a document viewer is assigned to the client device 102a, and a host process of a dictionary search service is assigned to the client device 102b. Each of the client devices 102a and 102b includes a display 106a, which displays an image and has non-volatile storage capability. For example, the display 106a is composed of a cholesteric liquid crystal device or an electrophoresis device, and has a storing property which holds displayed image even when the supply of power is cut off.

Also, the host device 101 includes a pen 103, in communication, by wire or other suitable means including wirelessly, with the host device 101, with which an operator inputs a designation into one or both of the client devices 102a and 102b. The pen 103 of this embodiment, as well as being an operation designation portion for designating an operation to be carried out on the client device 102a or 102b, also functions as an operation determination unit which determines details of the operation carried out, in conjunction with a designation information providing portion 211 to be described hereafter.

The determination of the operation details can be realized, for example, in the following way. That is, a client device-specific dot pattern with position codes diffused therein is provided in advance on the display 106 of client device 102a and/or 102b. Meanwhile, the pen 103 includes an imaging portion, which optically reads the dot pattern. The pen 103, when designating one point on the display 106, images the point, and sends imaging data to the host device 101. The host device 101, by decoding the imaging data, identifies the client device(s) 102a and/or 102b or specifies the designated point.

The host device 101 includes a processing portion 104 in order to identify the client device(s) 102a and/or 102b or specify the point. Also, the host device 101 includes a designation history recording portion 105. The designation history recording portion 105 is an operation detail recording unit which records information correlating a specified client device and details of an operation carried out on the client device (a position of the point designated on the client device).

According to the designation history recording portion 105, it is possible to record a fact that the pen 103, after designating a point (ax, ay) on the display 106 of the client device 102a, has gone on to designate a point (bx, by) on the display 106 of the client device 102b.

Next, a more detailed description will be given of an internal configuration of the host device 101 and client devices 102a and 102b. In this embodiment, client devices 102a and 102b have an identical function. For this reason, in this embodiment, only the configuration of the client device 102a will be illustrated in describing each of the client devices 102a and 102b.

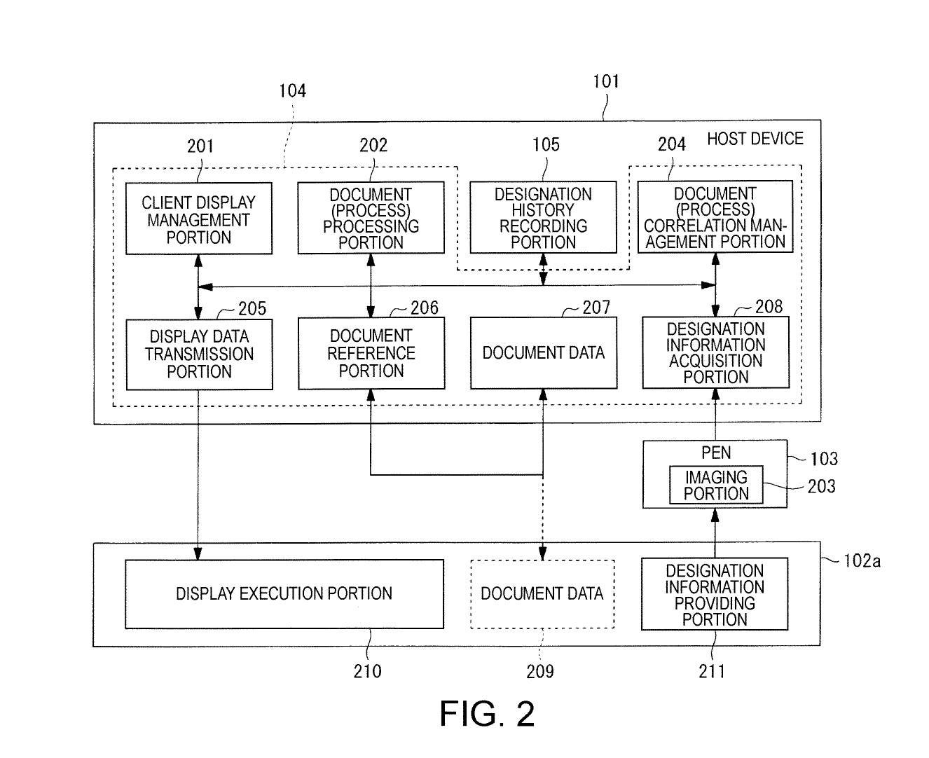

FIG. 2 is a diagram more specifically illustrating the internal configuration of the host device 101 and the client device 102a. As shown in the figure, the client device 102a includes the designation information providing portion 211 which provides designation information providing unique identification information for specifying each of them. According to the example described heretofore, the designation information being the dot pattern, it is possible, with the dot pattern, not only to identify the client device 102a, but also to provide the host device 101 side with information related to the point designated by the pen 103 on the display 106.

Also, in the case that a GUI (Graphical User Interface) indicating an operation designation (e.g., a copying or a cutting operation) is set on the display 106, it is possible to execute such an operation by designating a point on the GUI using the pen 103.

The pen 103 includes an imaging portion 203, which images the dot pattern. Data obtained by an imaging of the imaging portion 203 is transmitted to the host device 101.

In the above configuration, the dot pattern of the client device 102a corresponds to the designation information providing portion 211.

This embodiment is not limited to the configuration using the dot pattern as the designation information providing portion 211; it is also possible, in accordance with a position or an area designated on the display 106, by means of an electromagnetic-induced short range communication or the like, or a barcode, to provide the host device 101 side with a command related to the designation.

Also, the client device 102a receives display data to be updated, from the host device 101, as a result of a process which is carried out based on the information provided to the host device 101 by the designation information providing portion 211. The client device 102a includes a display execution portion 210, which causes an image based on the display data to be displayed on the display 106. The display execution portion 210 refers, for example, to a driver of the display 106 and a control portion of the driver.

Also, it is acceptable that the client device 102a receives at least one item of document data 209, for generating the display data as necessary, from the host device, and saves it.

Meanwhile, the host device 101 includes a designation information acquisition portion 208. The designation information acquisition portion 208 acquires the imaging data transmitted by the pen 103 and, as well as specifying, based on the data, the client device 102a or 102b for which the pen 103 has designated the point, acquires identification information of coordinates or an area of the designated point on the display 106.

The identification information of the client device(s) 102a and/or 102b, and the information of the coordinates or the area, which have been acquired by the designation information acquisition portion 208, are also transmitted to a document (process) correlation management portion 204, and are managed. Also, the host device 101 includes a client display management portion 201 which, having information indicating a correlation between the position on the display 106 and the GUI or the like, is for specifying a process requested by the operator based on the coordinates or the area.

In this embodiment, the designation information acquisition portion 208, based on the data managed by the client display management portion 201, ascertains what kind of document element is displayed in which position of the client device(s) 102a and/or 102b. As this kind of configuration, for example, it is also acceptable to define a common data format in the plurality of client devices and, as an independent task, interpret a relationship between the document and the display position. Also, it is acceptable to include the relationship between the document and the display position in each document processing processed by a document (process) processing portion 202, to be described hereafter, as a table.

Of the components described heretofore, the pen 103, which images the dot pattern on the display 106 and sends the imaging data to the host device 101, the designation information acquisition portion 208 and the client display management portion 201 cooperate to function as a specification unit, which specifies each of the client devices 102a and 102b, and the operation determination unit which determines the details of the operation carried out on the specified client device 102a or 102b.

Also, the host device 101 includes the designation history recording portion 105 which sequentially correlates and records the specified client devices and the designated points (the details of the operations) in accordance with an order of designation. The designation history recording portion 105, in this embodiment, serves as an operation detail recording unit which records information correlating the specified client device 102a or 102b with the details of the operation carried out on the determined client device.

In this embodiment, in a case in which the pen 103 operates the client device 102a or 102b, it is possible to specify the operated client device and a point or an area operated in the relevant client device. For this reason, the designation history recording portion 105, as described heretofore, can record operation history information indicating details of operations consecutively executed between the plurality of client devices 102a and 102b.

Also, the host device 101 includes the document (process) processing portion 202 which generates the display data in accordance with the operation details, document data 207 which is referred to when generating the display data in the document processing portion 202, a document reference portion 206 for referring to the document data, and a display data transmission portion 205 which transmits the generated display data to the client device 102a.

The display data transmitted to the client device 102a by the display data transmission portion 205 is caused to be displayed on the display 106 by the display execution portion 210 on the client device 102a side.

The processing portion 104 including the above configuration functions as an operation processing unit which, based on the information stored in the designation history recording portion 105, transmits information (the display data) obtained as a result of the operator's operation to any of the plurality of client devices 102a and 102b.

Next, a description will be given of an operation of the heretofore described information processing system of this embodiment.

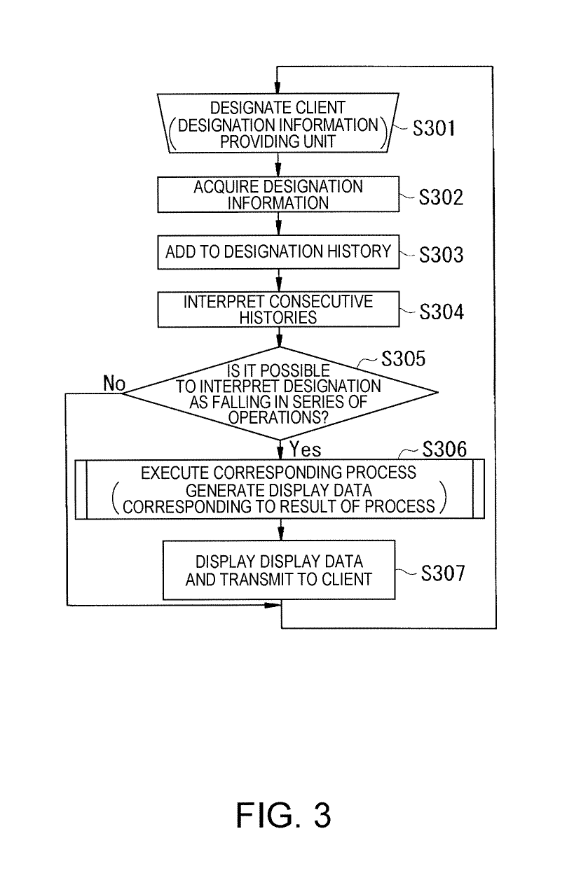

FIG. 3 is a flowchart for illustrating an overall operation of the information processing system of this embodiment. If the operator uses the pen 103 to designate one point on the display 106 of any of the plurality of client devices (S301), the information processing system of this embodiment starts to operate.

The designation information providing portion 211 of the host device 101 acquires, from the client device side, information indicating which position on the display 106 of which client device has been designated (S302). The acquired information is added to the designation history recording portion 105, and temporarily saved (S303).

Furthermore, the designation information acquisition portion 208 interprets consecutive histories in a record in the designation history recording portion 105 (S304), and judges whether or not an operation executed at this time can be interpreted as falling in a series of designations following on from a previous operation (S305). If it cannot be interpreted as falling in the series of designations (S305: No), in this embodiment, the system awaits designation of a next client device. This kind of process is employed when an action operating the client device(s) 102a and/or 102b by designating one point on the display 106 is seen as one by which the operation is not completed only by one designation.

Also, if the consecutive designations of the point on the display 106 can be interpreted as falling in a series of operations (S305: Yes), a process correlated with the relevant point is determined and executed (S306). The correlation of the designated point with the process is determined based on the data managed by the client display management portion 201. The execution of the process includes a process in which the document processing portion 202 generates display data to be displayed as a result of the execution of the process.

The generated display data is transmitted to the client device(s) 102a and/or 102b via the display data transmission portion (S307).

According to the above program for causing the computer to execute the client device control method, for example, the following operation is possible. That is, in the event that the operator uses the pen 103 to select a part of the document displayed on the client device 102a, and designates a GUI indicating a copying to a clipboard, the designation information providing portion 211 provides the pen 103 with information specifying a client device, of which a point has been designated, and information indicating a position of the designated point.

In the host device, the specified client device and the position of the point on the display 106 of the relevant client device are compared with the data managed by the client display management portion 201. Then, letter string data or the like displayed at the point designated by the pen 103 are specified. Also, it is determined that the designation of the point indicates a copying operation. A result of the determination is stored in the designation history recording portion 105.

Next, in the event that the operator designates a point included in a place into which is entered a search letter string on the display 106 of the client device 102b and, furthermore, designates a GUI indicating a pasting, the designation information providing portion 211 detects that an operation of a pasting into the designated place has been requested. The designation of the pasting is temporarily stored in the designation history recording portion 105.

Also, the document processing portion 202 of the host device 101 refers to the record in the designation history recording portion 105. Then, it detects that a copying of letter string data has previously been designated, and determines that the pasting at this time is to paste the letter string data of which the copying has been designated. In this case, it is interpreted that the consecutively designated points indicate the series of operations.

The document processing portion 202 generates display data for synthesizing the letter string data selected at the time of the copying operation with the place into which is entered the search letter string of the client device 102b. The display data transmission portion 205 transmits the generated display data to the client device 102b. As a result of the above operation, an image in which the letter string data selected in the client device 102a is synthesized with the place designated in the client device 102b is displayed on the display 106 of the client device 102b.

In this way, in the information processing system of this embodiment, it is possible to execute the operation straddling the client device 102a and the client device 102b. In this embodiment, the operation straddling the plurality of client devices, not being limited to the copying and pasting of the letter string data or the like, needless to say, is also applicable to another command to copy a hyperlink or edit the document.

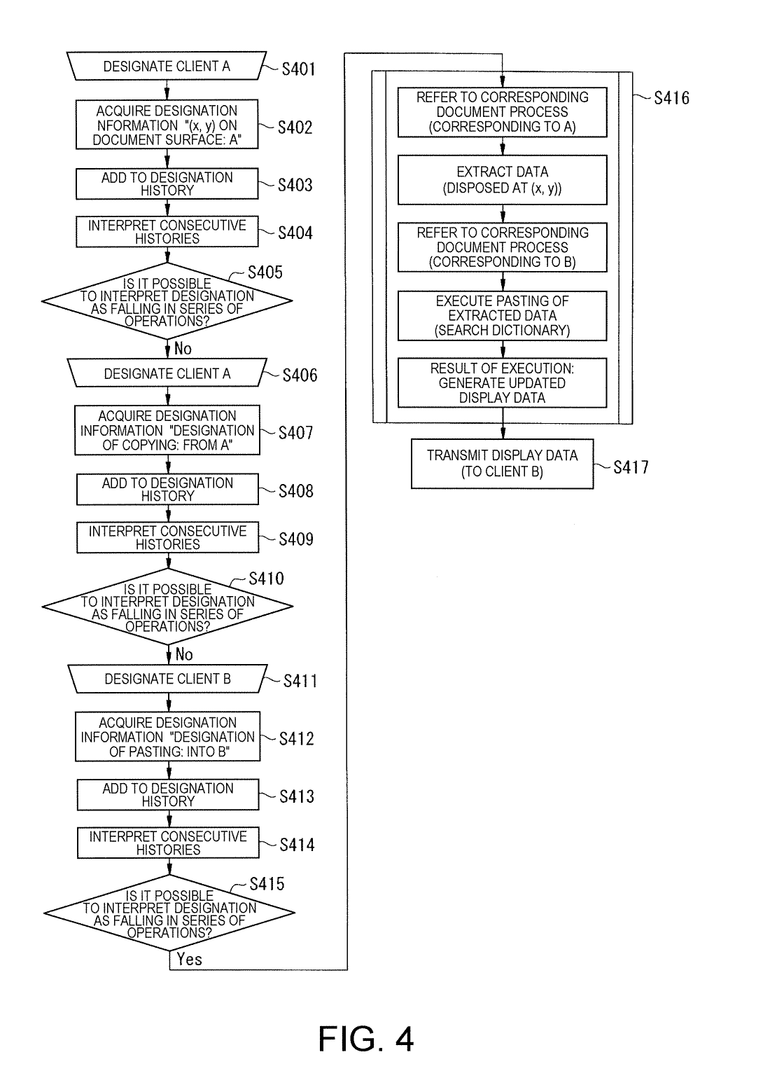

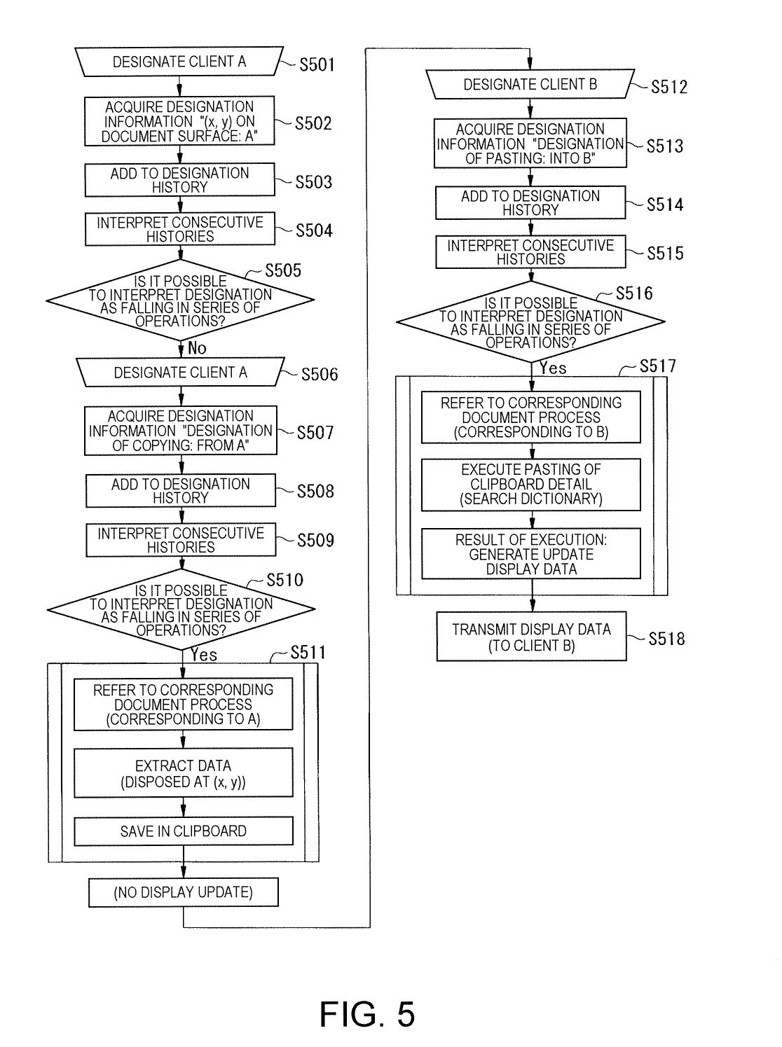

FIGS. 4 and 5 are flowcharts for more specifically illustrating the above operation, both of which are processes carried out on the host device side. However, FIG. 4 is an example in which the operations of the copying to the pasting are interpreted as falling in a series of processes, while FIG. 5 is an example in which each of the copying operation and the pasting operation is interpreted as falling in the series of processes. FIGS. 4 and 5 are both flowcharts into which the process of step S305 shown in FIG. 3 is developed.

In the flowchart of FIG. 4, if the operator uses the pen 103 to designate one point on the display 106 of the client device 102a, an operation starts (S401). At this time, a signal indicating that the point on the display 106a (in the flowchart, a document surface: A) of the client device 102 has been designated, and that coordinates of the point are (x, y), is sent from the pen 103 to the host device 101 side (S403).

The host device 101 receives the signal and adds a record to the effect that the point (x, y) on the display 106a has been designated to the designation history recording portion 105 (S403). The designation information acquisition portion 208 interprets the consecutive designations in a designation history (S404), and judges whether or not the operations in step S401 to step S404 can be interpreted as falling in the series of operations (S405). In the case of this embodiment, as only the designation of the point (x, y) cannot be interpreted as falling in the series of operations, it is judged in step S405 that they cannot be interpreted as falling in the series of operations.

As described heretofore, the flowchart of FIG. 4 is a process into which the judgment in step 305 is developed, and step S405, as well as step S410, to be described hereafter, is a process in which the judgment is No (S305: No). Also, step S415, to be described hereafter, is a process in which the judgment is Yes in step S305 (S305: Yes).

To continue, if the operator operates an operating portion such as an operating button or the like of the client device 102a to input a designation into the client device 102a, the host device 101 detects that designation details corresponding to the operating portion are, for example, the “copying” (S407). Then, it adds a fact that the copying has been designated to the designation history recording portion 105 (S408). Then, it interprets the consecutive designations in the designation history (S409), and judges whether or not the operations in step S401 to step S407 can be interpreted as falling in the series of operations (S410). In the example of FIG. 4 in which the operations up to the copying are not interpreted as falling in the series of operations, they are not interpreted as falling in the series of operations in step S410, either.

Furthermore, if the operator operates the client device 102b to designate the pasting (S411), the designation information acquisition portion 208 detects that the pasting has been designated in the client device 102b (S412). Then, it adds the information to the designation history recording portion 105 (S413). Then, it interprets the consecutive designations in the designation history (S414), and judges whether or not the operations in step S401 to step S413 can be interpreted as falling in the series of operations (S415).

In the example of FIG. 4, it is judged that operations from a designation of a position of an image to be an operational object (an image selection), through the copying, to the pasting fall in the series of operations (S415: Yes). Then, display data obtained as a result of the series of operations is generated, and a process of sending it to the client device is executed (S416).

That is, the host device 101 refers to the document correlation management portion 204, and detects an operation carried out on the client device 102a (the image selection or the like). Then, it extracts data of an image displayed at the designated point (x, y). Also, it refers to the document correlation management portion 204, and detects an operation carried out in the client device 102b. As the detected operation is the pasting, in this embodiment, the data extracted in the client device 102a is pasted in the client device 102b.

The document processing portion 202 generates display data in which the data extracted in the client device 102a is synthesized on a screen displayed in the client device 102b.

After the above process, the host device 101 transmits the display data to the client device 102b via the display data transmission portion 205 (S417).

Also, in the flowchart of FIG. 5, if the operator uses the pen 103 to designate one point on the display 106 of the client device 102a, an operation starts (S501). At this time, a signal indicating that the point on the display 106a (in the flowchart, a document surface: A) of the client device 102 has been designated, and that coordinates of the point are (x, y), is sent from the pen 103 to the host device 101 side (S503).

The host device 101 receives the signal, and adds a record that the point (x, y) on the display 106a has been designated to the designation history recording portion 105 (S503). The designation information acquisition portion 208 interprets the consecutive designations in the designation history (S504), and judges whether or not the operations in step S501 to step S504 can be interpreted as falling in the series of operations (S505). In the case of this embodiment, as only the designation of the point (x, y) cannot be interpreted as falling in the series of operations, it is judged in step S505 that it cannot be interpreted as falling in the series of operations.

As described heretofore, the flowchart of FIG. 5 is a process into which the judgment in step S305 is developed, and step S505 is a process in which the judgment is No in step S305 (S305: No). Also, steps S511 and S516, to be described hereafter, are processes in which the judgment is Yes in step S305 (S305: Yes).

To continue, if the operator operates an operating portion, such as an operating button of the client device 102a, to input a designation into the client device 102a, the host device 101 detects that designation details corresponding to the operating portion are, for example, the “copying” (S507). Then, it adds a fact that the copying has been designated to the designation history recording portion 105 (S508). Then, it interprets the consecutive designations in the designation history (S509), and judges whether or not the operations in step S501 to step S507 fall in the series of operations (S510).

In the flowchart of FIG. 5, as described heretofore, each of the copying and pasting operations is interpreted as falling in the series of operations. For this reason, a copying process corresponding to the copying operation is executed (S511). In the copying operation, the document correlation management portion 204 is referred to, and an operation carried out on the client device 102a (an image selection or the like) is detected. Then, data of an image displayed at the designated point (x, y) are extracted. Furthermore, the extracted image data are saved on the clipboard. In this embodiment, after the above process, the display in the client devices 102a and 102b is not updated. However, for example, in a case of a cutting operation, display data reflecting a cutting condition are generated and, by transmitting them to the client device 102a, it is possible to update a display condition.

Furthermore, if the operator operates the client device 102b to designate the pasting (S512), the designation information acquirement portion 208 detects that the pasting has been designated in the client device 102b (S513). Then, it adds the information to the designation history recording portion 105 (S514). Then, it interprets the consecutive designations in the designation history (S515), and judges whether or not the operations in step S501 to step S513 can be interpreted as falling in the series of operations (S516). As a result of the judgment, in the example of FIG. 5, a pasting process corresponding to the pasting operation is executed (S517).

In the pasting operation in step S517, firstly, the host device 101 refers to the document correlation management portion 204, and detects an operation carried out in the client device 102b. As the detected operation is the pasting, in this embodiment, the document processing portion 202 generates display data in which the data saved on the clipboard in a series of processes included in step S511 are synthesized on the screen displayed in the client device 102b. The generated display data are transmitted to the client device 102b via the display data transmission portion 205 (S518).

The heretofore described program for causing the computer to execute the client device control method is provided by recording it in a computer readable recording medium, such as a CD-ROM, a floppy (a registered trade name) disk (FD) or a DVD, which is a file of an installable format or an executable format. Also, it is acceptable to configure in such a way that the program for causing the computer to execute the client device control method according to this embodiment is provided by storing it on the computer connected to a network such as an internet, and downloading it by way of the network.

Also, it is acceptable that the heretofore described program for causing the computer to execute the client device control method according to this embodiment is provided by recording it in a computer readable memory device, such as an ROM, a flash memory, a memory card or a USB connection type flash memory.

According to the heretofore described embodiment, even in the host-client type information processing system in which one host device is connected to the plurality of client devices 102a and 102b, it is possible, based on the operations executed straddling the plurality of client devices 102a and 102b, for the host device to rewrite the display data of the client devices.

With this kind of information processing system, it is possible to give the operator a kind of operating sensation of having moved an image or a letter displayed on one of two paper media to the other. Also, it is possible to increase an operability of the storage display body material applied to the client devices, and bring the operability close to that of the paper media.

The entire disclosure of Japanese Patent Application No. 2006-83049, filed Mar. 24, 2006 is expressly incorporated by reference herein.

What is claimed is:

1. An information processing system, comprising:
a host device, and a plurality of client devices, each of which is in communication with the host device, each of the plurality of client devices having unique identification information for specifying that client device, wherein the host device includes:
a specification unit configured to detect the identification information and specify each of the client devices;
an operation determination unit configured to determine details of an operation carried out on the client device specified by the specification unit;
an operation detail recording unit configured to record information correlating the client device specified by the specification unit and the details of the operation carried out on the client device which has been determined by the operation determination unit; and
an operation processing unit configured to, based on the information recorded in the operation detail recording unit, generate information obtained as a result of operations consecutively executed between the plurality of client devices, and transmit the generated information to any of the plurality of client devices.

2. The information processing system according to claim 1, wherein
the operation determination unit, being connected by wire or wirelessly to the host device, is further configured to transmit the details of the operation carried out on the client device to the host device.

3. The information processing system according to claim 1, wherein
at least one of the plurality of client devices includes a display device which displays an image and has a non-volatile storing property.

4. A program for causing execution in a host device of an information operating system a method of controlling any of a plurality of client devices included in the system, the program comprising:
instructions for specifying each of the plurality of client devices;
instructions for determining details of an operation carried out on a specified client device;
instructions for recording information correlating the specified client device and the details of the operation carried out on the specified client device which has been determined; and
instructions for, based on the information recorded in the operation history recording step, transmitting information obtained as a result of operations consecutively executed between the plurality of client devices to any of the client devices.
